(19) United States
(12) Patent Application Publication
(10) Pub. No.: US 2004/0083163 A1
(43) Pub. Date: Apr. 29, 2004

(54) System and method for purchasing increased efficiency items

(76) Inventor: Michael Cooper, Tahlequah, OK (US)

Correspondence Address: Jennifer Meredith, Suite 7720, 350 Fifth Avenue, New York, NY, 10118, US

(21) Appl. No.: 10/280,957

(22) Filed: Oct. 24, 2002

(51) Int. Cl. G06F 17/60

(52) U.S. Cl. 705/38

(57) ABSTRACT

The present invention provides a system and method for offering incentives related to the purchase of increased efficiency items. The method may comprise the steps of: offering to a consumer at least one increased efficiency item; determining the consumer's credit rating; determining loan data for a loan agreement; determining the cost savings associated with each at least one increased efficiency item; determining the cost of a similar standard item for each at least one increased efficiency item; and providing a proposed loan agreement for each at least one increased efficiency item, wherein the total payment for a specified period of the proposed loan agreement is less than or equal to the cost savings for the specified period associated with each at least one increased efficiency item plus the cost of a similar standard item for the specific period.

### BACKGROUND OF THE INVENTION

This invention relates to financial management systems and more specifically, to a system and method for matching vendors, consumers and lenders so that a consumer may purchase an increased efficiency item.

Many items provide substantial cost and environmental benefits over the long term. However, many also require substantial investments up front. Many consumers find the initial payout to be prohibitive. Because of this, they may avoid purchasing items that are better for the environment and buy those that are less expensive or keep existing equipment. By way of example, these items may include geothermal heat pumps, energy efficient hybrid cars, compact fluorescent lights (cfl's), and energy efficient appliances.

Over the past several decades, rising concentrations of greenhouse gases have been detected in the Earth's atmosphere. It has been hypothesized that the continued accumulation of greenhouse gases could lead to an increase in the average temperature of the Earth's surface and cause a variety of changes in the global climate, sea level, agricultural patterns, and ecosystems that could be, on net, detrimental. In response to these threats the Kyoto Protocol, a treaty designed to reduce worldwide greenhouse gas emissions, was enacted. The Kyoto Protocol outlined a set of specific actions designed to ensure reduced emissions. At the request of the U.S. House of Representatives Committee on Science, the Energy Information Administration (EIA) performed an analysis of the Kyoto Protocol, focusing on the potential impacts of the Protocol on U.S. energy prices, energy use, and the economy in the 2008 to 2012 time frame. Energy Information Administration's Annual Energy Outlook 1998 (AEO98) projects that energy-related carbon emissions will reach 1,803 million metric tons in 2010, 34 percent above the 1990 level. Because energy-related carbon emissions constitute such a large percentage of the Nation's total greenhouse gas emissions, any action or policy to reduce emissions will have significant implications for U.S. energy markets. However, the government is in a state of constant budget cuts. Because of this, it would be desirable to implement a system and method for providing energy efficient consumer items that may be a flexible, market driven system.

For years, consumers have been invited by sellers and finance institutions to apply for credit (including loans and leases) in order to purchase consumer durable goods such as houses, vehicles, boats, large appliances, and the like. To obtain financing for such purchases, the consumer would fill out a credit application which would include personal information relevant to its identity and creditworthiness. This information was then distributed in some manner to a finance institution in the business of writing terms for loan or lease “products.” The finance institution would research the creditworthiness of the individual using various resources and respond by phone or fax to the applicant with an “approval,” pending documentation and other due diligence, or a “denial” of the application.

For purposes of this description, when a consumer sends information directly to a particular finance institution, the consumer is applying for “direct financing.” When an intermediary of any sort, such as a vendor of the desired goods, is used to gather and distribute applicant information to one or more finance institutions, the term “indirect financing” is used.

Indirect financing is valuable to finance institutions or “lenders”, sellers, and consumers alike. Lenders benefit from the arrangement in that they can capitalize on the “front line” presence of sellers to generate applicants for their finance products. Sellers have benefited in two ways: one, their customer is able to obtain funds to buy their goods; and two, the finance institution will often reward the seller for sending them a new customer. The consumer's benefit by obtaining financing for something they desire on terms acceptable to them.

The traditional avenues of indirect financing suffer from drawbacks and limitations. Prior to the invention, indirect financing was generally time consuming and costly, and was generally limited to an individual seller's access to finance product resources, and its skill and effort made in finding available finance products suitable for the customer. Moreover, depending on consumer credit quality, most credit applications that a lender receives through indirect channels do not result in a favorable outcome for anyone and yet, based on applicable Federal regulations, finance institutions are legally required to process and either approve or deny all credit applications received. For denied credit applications, the lender must prepare and forward a letter to the applicant stating that the application was denied. This procedure is costly and time consuming. It is also expensive for finance institutions to develop and maintain relationships with indirect channels.

The transfer of money from a first party to a second party may occur according to a multitude of different methods and systems. Some of the considerations in the transfer of money may include: if, when and how the money will be returned, compensation for the use of the funds, the credit worthiness of the borrower and the ability of the transferring party to sell, mortgage or assigned its position in the instrument acquired.

Fixed rate debt involves the transferring party (“lender”) and the accepting party (“borrower”) agreeing when the principal will be returned, the rate at which interest will accrue and when it will be paid. The lender's compensation is fixed and not determined on the profitability of the enterprise, other than the borrower's ability to meet the debt obligation. Lenders in accepting fixed rate debt instruments must anticipate the effects of inflation, changes in the credit of the borrower, changes in market interest rates, value of the loan and future cash flow characteristics. Lenders traditionally compensate for uncertainties in the interest rate charged on the loan.

By way of example, an investor purchasing a 10 year noncallable government bond priced to yield 7% is accepting a yield which represents the market's current assessment of reasonable compensation for a 10 year term, including compensation for future inflation. Since the obligation is of a high credit quality (the government is credit worthy) and highly liquid, little if any additional “premium” is added to the interest rate. As in well known within the art, riskier borrowers must pay a “premium” or a higher loan rate. Also, the shorter the time span, the less risk there is of inflation or fluctuations in interest rates. A loan priced over 1 year is less subject to interest rate variations than a 30-year loan.

For borrowers, long term fixed rate callable debt obligations may not be very attractive. Such debt obligations allow the borrower to borrow at long term rates which might become inexpensive compared to the market if rates rise, while allowing early repayment if rates fall. Unless the borrower has excellent credit or the interest rate on the obligation is extremely high compared to the marker, it is less likely the credit markets will accept callable long-term fixed rate debt from such a borrower. If the debt is non-callable the borrower risks the possibility of comparatively more expense financing if rates fall.

Variable rate debt is also known within the art. Generally, the transferring party “lender” and the accepting party “borrower” agree when and the terms under which principal will be repaid, as well as an index to be used to determine the rate at which interest will periodically accrue, and when it will be paid. Variable debt instruments may be issued on a short-term or long-term basis. Generally, variable rate instruments compensate the lender for the use of funds on the basis of current market rates. By way of example, a short term variable loan to a highly rated credit might currently be 4.75% representing a 75 basis point premium for credit and liquidity risks. This may be more desirable to a lender than a 10 year fixed rate treasury bond yielding 6%. While the short term loan may be at a rate of 4.75% compared with 6%, there is less exposure to the lender. The lower rate is merely the market perception of the loan at the present point in time. However, the variable nature of the loan allows for variations and thus reduces risk to the lender for market fluctuations.

Various debt instruments, equity instruments and derivative securities are known within the art for transferring monies from a first party to a second party. Generally parties loaning money to an enterprise are compensated only through interest, except to the extent a capital gain is recognized on the instrument. This gain still comes from the commitment of the borrower to pay interest at a predetermined rate in the future.

Debt holders are generally exposed to two primary risks: I) changes in interest rates during the life of the loan, and ii) the ability of the borrower to repay principal and interest. Generally, a lender should not lend money unless they are confident of the borrowers ability to repay. However, a premium on the interest rate may affect a lenders willingness to lend to less credit worthy individual.

In order to properly assess the risks of a particular loan, the lender and borrower must consider the use of the proceeds and costs of funds. If the lender has a fixed cost of funds, then a fixed rate long-term loan matched to its underlying source of funds may permit it to profit from the “spread” between its cost of funds and the rate on the loan. Any increase or decrease in market interest rates are of no consequence to the lender. Any deterioration in credit or prepayment of the loan, however, could expose the lender to risk in its ability to compensate its source of funds or measure certain future payment objectives.

For the borrower, a long-term fixed rate source of funds may be appropriate if the use of the proceeds generate a cash flow stream more than sufficient to repay interest and principal on the loan. The arrangement provides the borrower protection against increased financing cost if rates increase while foregoing reduced costs if interest rates were to decrease. A risk the borrower assumes in a non-callable fixed rate financing is that the purpose for which the loan proceeds was used does not produce the desired revenue or terminates prior to the maturity of the loan. If the borrower's capital and other revenues are insufficient to pay interest and principal on the loan to maturity, then credit quality may deteriorate increasing the lender's risk. This risk can be reduced for the borrower by permitting early redemption of the loan. Often the lender will require a prepayment penalty, call premium, and/or an increased rate of interest through out the financing term. This option then becomes more appropriate for a lender with a variable cost of funds.

Risk for a lender with a variable cost of funds, or who bases investment performance on current market rates of interest, can be managed and returns enhanced in a variety of different ways. Existing markets currently provide lenders a means of reducing inflation rate exposure through varying maturities of debt instruments they purchase. A lender could invest in long-term government obligations. Under some interest rate scenarios, the interest on long-term obligations is significantly more than that of short-term obligations. This increased compensation is a result of a longer term and accepting a fixed rate for the long-term government obligations. The lender may further increase potential compensation by accepting a corporate obligation, thereby adding credit risk to its mix of exposures. If the rates increase, the carrying value of the instruments can substantially decrease and may result in lower investment earnings when compared to short-term government bonds. If interest rates decline, the carrying value of the instruments may substantially increase and result in higher investment earnings when compared to short-term government bonds. This risk may also be transferred through a fixed to floating rate interest swap contract or other form of derivative security. The cost, when combined with interest earned may be greater than current rates on short-term government obligations.

Liquidity is another method of protecting a lender from changes in inflation or interest rates, as well as economic uncertainty, by allowing a debt obligation to be sold. Specialized debt obligations, though, or those with deteriorating credit quality (which may result from the market's analysis of the impact of these changes on the obligor) may have limited liquidity and thus leave the lender exposed to risks. Sometimes these risks may be transferred to an insurer through financial guarantee insurance. Generally this is available only for investment grade obligations, and is most often used for municipal government securities. Consequently, investors purchasing long-term corporate debt obligations must often bear the risk of deteriorating credit or liquidity, inflation and other risks without adequate compensation.

For users of funds, the optimum borrowing scenario may be that the characteristics of financial instruments issued by the borrowers match as closely as possible the characteristics of the objective being financed. When this involves fixed rate debt which may be prepaid, the cost of the financing increases and the availability of lenders funds decreases.

In some instances, floating rate loans do not adequately match interest costs to revenue generated from the activity financed. In effect, interest cost becomes a variable to the borrowing enterprise. Revenues may not even cover debt servicing costs. If the borrower's costs of funds are tied to a variable interest rate, any increase may cause further problems and cause the borrowers credit to decline. Because of this decline, the lender may require even further increased interest rates. This can cause a multitude of problems for the borrower and the lender.

Also, known within the art is the use of rebates to entice buyers to purchase larger ticket items. U.S. patent application Ser. No. 2002/0,128,942 A1 to Colosi discloses a method of obtaining a rebate. The method includes the steps of selling a product or service to a buyer for a price at a first point in time, providing the buyer with an expectancy of a rebate, wherein the expectancy equals a first amount at the first point in time, investing at least a portion of the first amount in a financial investment vehicle, and providing the rebate to the buyer after a predetermined amount of time. After the predetermined amount of time, the rebate equals a second amount. The second amount is equal to what the first amount has matured to in the financial investment vehicle during the predetermined amount of time. The second amount is approximately equal to the original price. While such a system may serve to benefit the buyer and the seller, what is needed is a system and method that provides entices buyer to purchase items that they normally would not.

U.S. patent application Ser. No. 2002/0,111,860 discloses a method and system for distributing or obtaining incentives related to the purchase or acquisition of a product or service, whereby the incentive can be offered on the condition that the purchaser of the product or service agrees to receive an interposed communication, which can be any multimedia message including advertisement, informative information, or survey.

Other references generally showing electronic means for processing loan or other applications include U.S. Pat. No. 4,194,242 to Robbins, U.S. Pat. No. 4,876,648 to Lloyd, U.S. Pat. No. 5,239,462 to Jones, et al., U.S. Pat. No. 5,523,942 to Tyler, et al., U.S. Pat. No. 5,611,052 to Dykstra, et al., U.S. Pat. No. 5,673,402 to Orion, et al., U.S. Pat. No. 5,699,527 to Davidson, U.S. Pat. No. 5,6742,775 to King, and U.S. Pat. No. 5,765,144 to Larche, et al.

Accordingly, there is a need within the prior art to provide a system and method for the purchase or acquisition of increased efficiency items that may be cost prohibitive, but which may benefit the consumer, the vendor and the lender. The increased efficiency items may also be environmental friendly, resulting in reduced emissions or decreased pollution.

### SUMMARY OF THE INVENTION

It is envisioned that the present invention may be utilized as a stand alone system, website, or a portion of a website. The system and methods according to the present invention will allow consumers to purchase increased efficiency items, e.g. energy efficient heating and cooling systems, wherein their monthly, or any other periodical payment, is less than equal to the amount it would have been had they purchased the less efficient items. That is, the total cost to the consumer will be the same or less than the cost of purchasing the less efficient item when accounting for realized cost savings.

According to another aspect of the present invention, a system for matching vendors, consumers and lenders for the purchase of an increased efficiency item, is disclosed comprising: means for receiving loan data from lenders and for storing the loan data in a computer storage device; means for receiving item information from vendors regarding at least one increased efficiency item and for storing the item information in a computer storage device; means for determining estimated cost benefits to the consumer for each at least one increased efficiency item; means accessible to the computer storage device for using the loan data, item information and estimated benefits to create a list of negotiated terms and conditions of a loan agreement for each at least one increased efficiency item within an identified lender; means for receiving a selection from the consumer for at least one increased efficiency item to provide a selected item, wherein the consumer agrees to finance the selected item according to the loan agreement; and a means for delivering the selected item to the consumer.

According to a further aspect of the present invention, a system for matching vendors, consumers and lenders for an increased efficiency item, is disclosed comprising: a means for receiving loan data from lenders and for storing the loan data in a computer storage device, wherein the loan data includes at least one of principal balance of the loan, term, initial period interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark and currency of the loan; means for receiving item information from vendors regarding at least one increased efficiency item and for storing the item information in a computer storage device; means for determining estimated cost benefits, in comparison to a standard comparable item, to the consumer for each increased efficiency item; means accessible to the computer storage device for using the loan data, the item information and the estimated benefits to create a list of negotiated terms and conditions of a loan agreement for each at least one increased efficiency item within an identified lender, wherein the means accessible to the computer storage device for using the loan data is a host system; loan agreement negotiation means coupled to the computer storage devices for the borrower and at least one lender to enter, record and store the terms of the loan agreement, prepayment terms, loan adjustments. The loan adjustments may comprise changes to costs, points, rates, margins, external benchmarks, caps or life caps to be made. There may also be a restriction means coupled to the computer storage device for identifying and entering particular terms under which funds received from the issuance of the loan agreement will be accepted by the consumer. There may be a means for receiving a selection from the consumer for at least one increased efficiency item to provide a selected item, wherein the consumer agrees to finance the selected item according to the loan agreement; and a means of delivering the selected item to the consumer.

According to another embodiment, a method for offering incentives related to the purchase of increased efficiency items is disclosed comprising the steps of: offering to a consumer at least one increased efficiency item; determining the consumer's credit rating; determining loan data for a loan agreement; determining the cost savings associated with each at least one increased efficiency item; determining the cost of a similar standard item for each at least one increased efficiency item; and providing a proposed loan agreement for each at least one increased efficiency item, wherein the total payment for the proposed loan agreement for a specified period is less than or equal to the cost savings associated for the specific period for each of at least one increased efficiency item plus the cost of a similar standard item for the specific period.

According to another embodiment, a method of implementing a loan for the purchase of increase efficiency items through a distributed system of computers is disclosed. Each of the computers having their own memory. The memory stores information relating to the loan or loan information. The loan information may include principal balance of the loan, a term of the loan, and an interest rate of the loan. The method comprising the steps of: determining the cost of at least one increased efficiency item offered for sale by a vendor; transmitting to a consumer a list with at least one increased efficiency item; determining the consumer's credit rating and storing the consumer's credit rating in memory; determining loan data for a loan agreement from a lender and storing the loan data in memory; determining the cost savings associated with each at least one increased efficiency item; determining the cost of a similar standard item for each at least one increased efficiency item; calculating a list of proposed loan agreements according information stored in the memory, wherein the information is selected from the group consisting of the cost of at least one increased efficiency item offered for sale by a vendor, the consumer's credit rating, the loan data, cost savings and cost of a similar standard item, and wherein the total payment for the proposed loan agreement for a specific period is less than or equal to the cost savings associated with each at least one increased efficiency item for the specific period plus the cost of a similar standard item for the specified period; transmitting a list of proposed loan agreements based upon the loan information for each at least one increased efficiency item accepting a purchase request from the consumer for at least one increased efficiency item wherein the consumer accepts the proposed loan agreement and agrees to accept at least one increased efficiency item; and delivering at least one increased efficiency to the consumer.

These and other features, aspects and advantages of the present invention will become better understood with reference to the following drawings, description and claims.

### BRIEF DESCRIPTION OF THE DRAWINGS

FIGS. 1A-1G depict a schematic diagram of a system according to the present invention;

FIG. 2 depicts a flowchart of a method according to the present invention; and

FIG. 3 depicts a flowchart of a method according to the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention, since the scope of the invention is best defined by the appended claims.

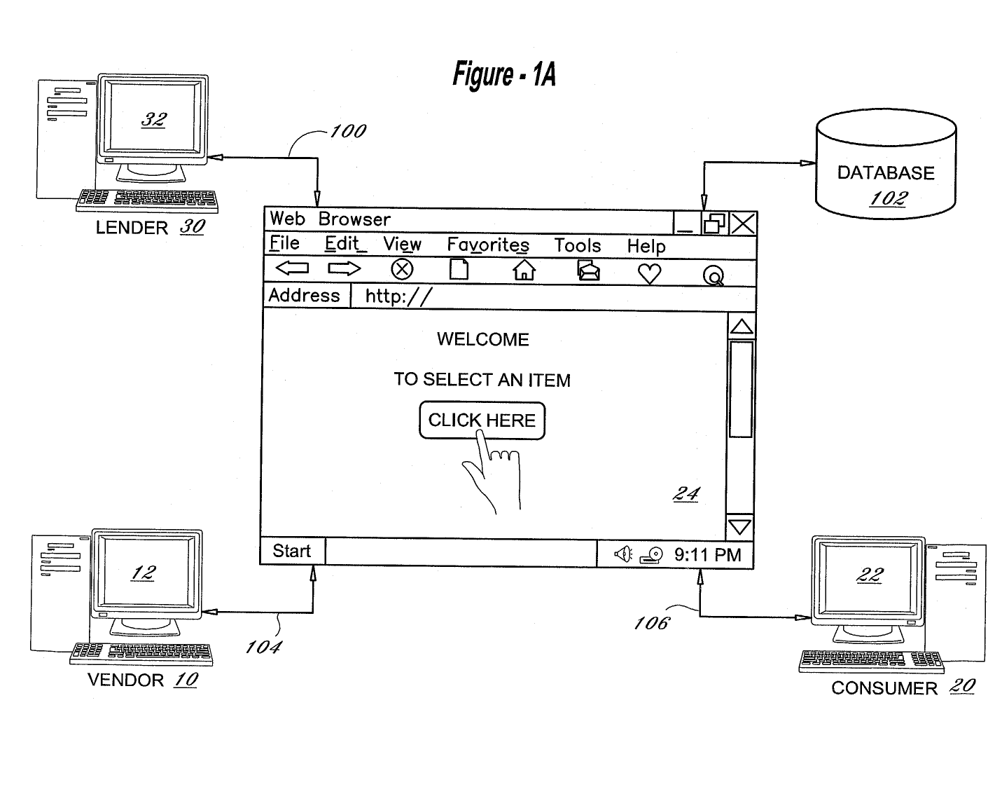

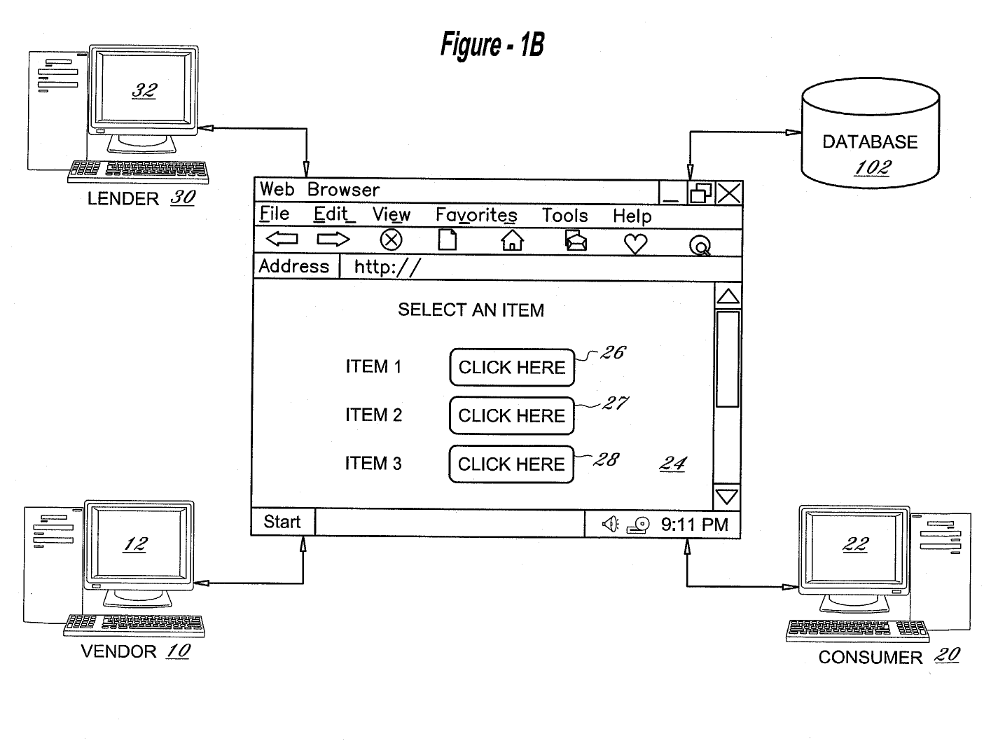

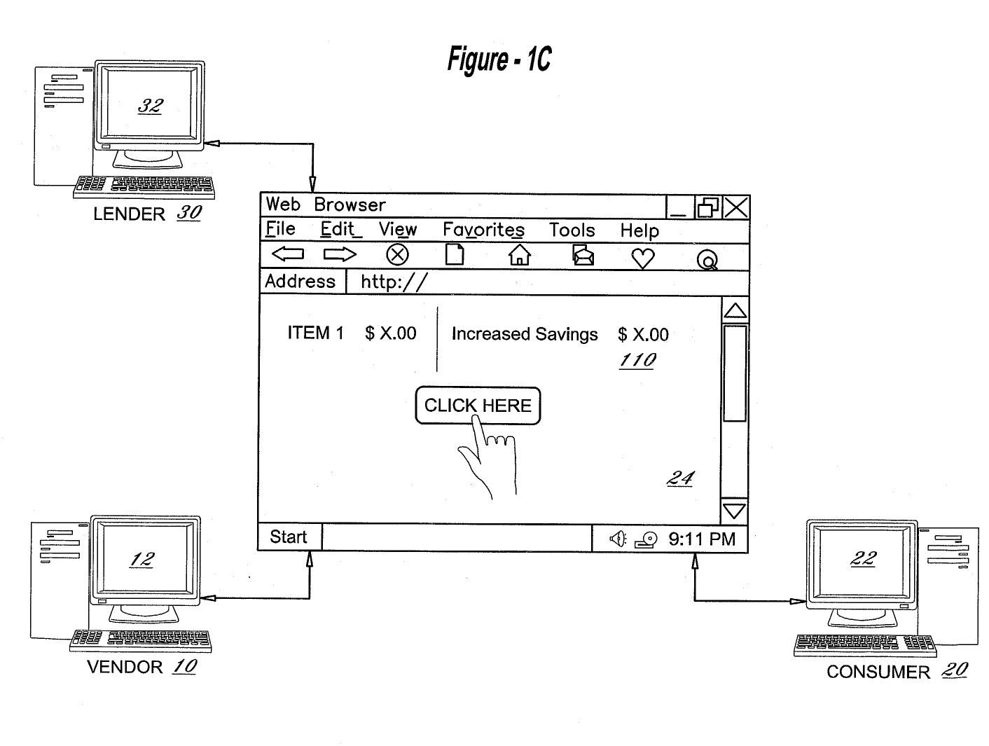

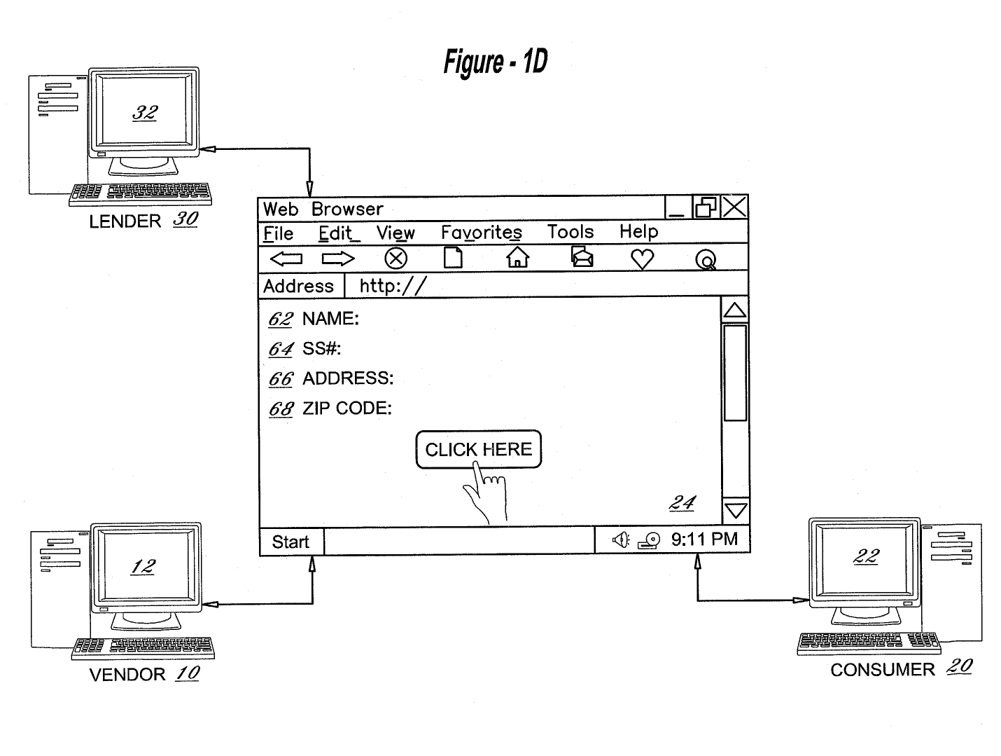

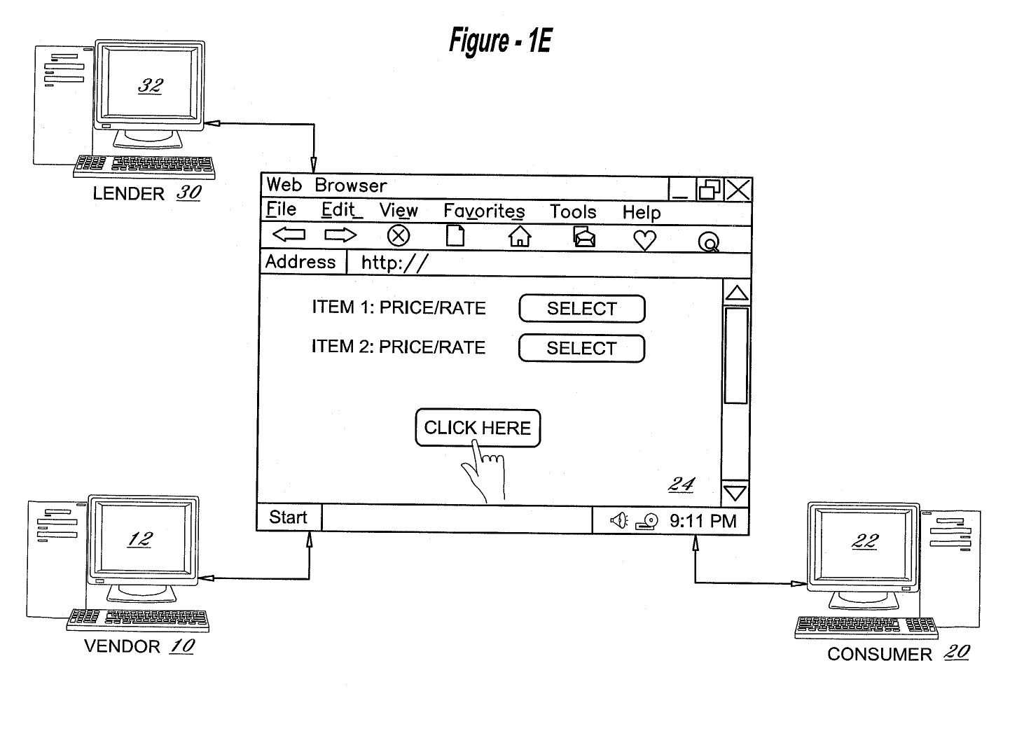

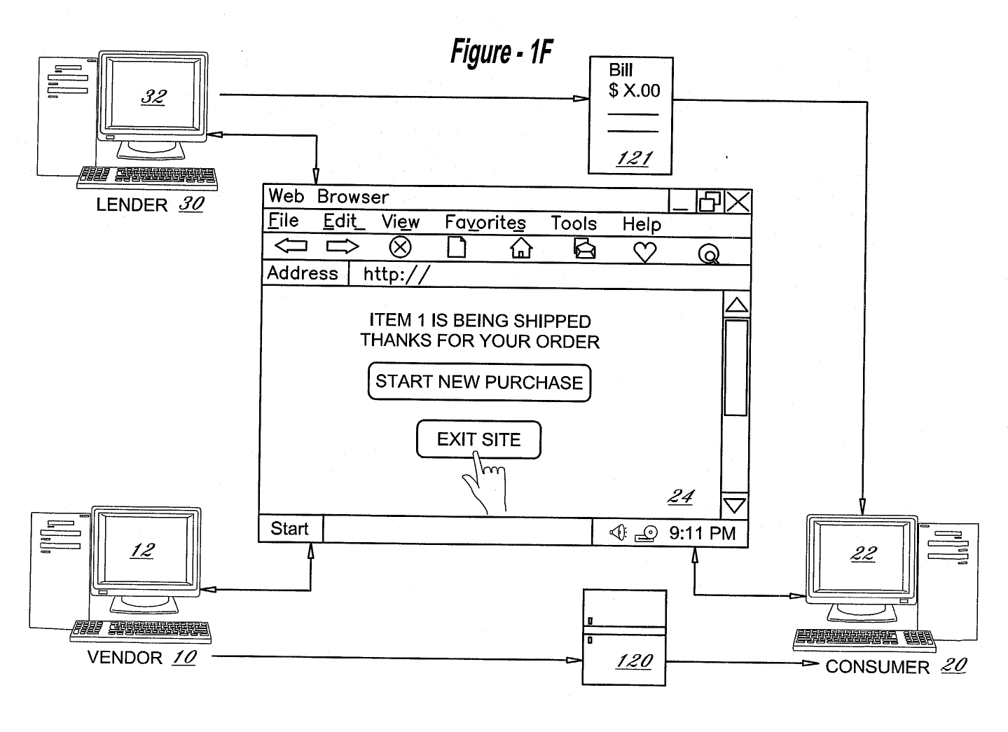

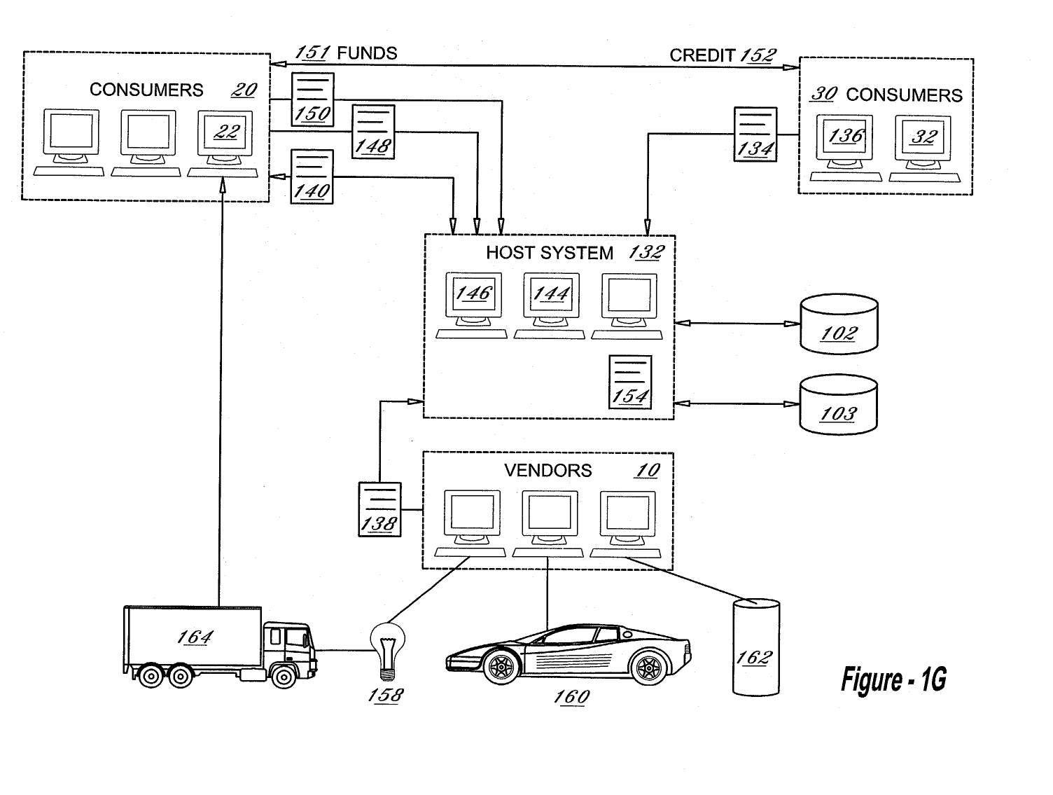

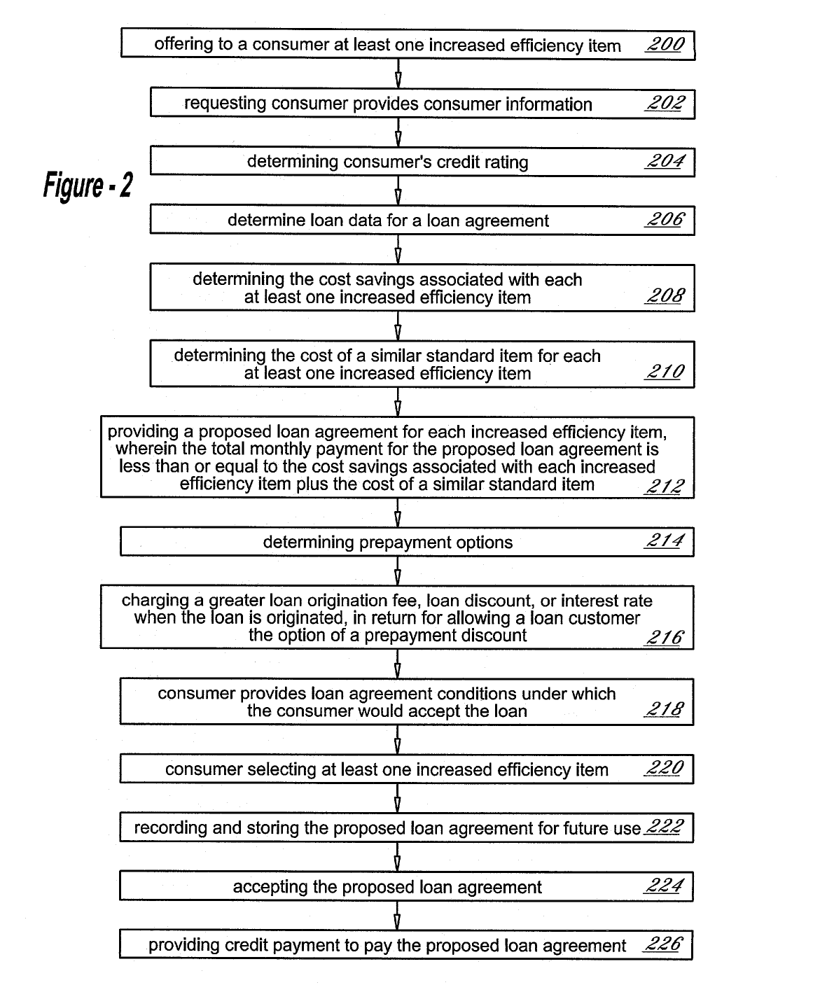

FIGS. 1A through 1G show a system for matching vendors, consumers and lenders for an increased efficiency item in accordance with the present invention. FIG. 1A shows a home page that prompts a consumer 20 to begin the selection of an item for purchase and further depicts a system for matching vendors 10, consumers 20 and lenders 30 for the purchase of an increased efficiency item. FIG. 1A shows a vendor 10, a consumer 20 and a lender 30 communicating by using their respective computers (vendor's computer 12, consumer's computer 22, lender's computer 32) over a telecommunications network. There may be a plurality of computers, but there must be at least one vendor 10 computer, at least one lender 30 computer and at least one consumer computer 20 for a transaction to occur. Vendor's computer 12 may be physically located off-site from vendor's place of business, hosted by an Internet service provider. Similarly, the consumer's computer 22 need not be owned by the consumer 20 or physically located at the consumer's home or business. It may be a community computer available for public use at a public place. According to the embodiment depicted, lender's computer 32 acts as a means for receiving loan data from lenders 30 and for storing the loan data in a computer storage device, which may be a database 102. Vendor's computer 12 acts as a means for receiving item information from vendors 10 regarding at least one increased efficiency item and for storing the item information in a computer storage device, which may be a database 102. There may be a means for determining estimated cost benefits to the consumer for each at least one increased efficiency item, this may be a database 102. The system may also have a means accessible to the computer storage device, database 102, for using the loan data, item information and estimated benefits to create a list of negotiated terms and conditions of a loan agreement for each at least one increased efficiency item within an identified lender (not shown). The system may have a means for receiving a selection from the consumer 20 for at least one increased efficiency item to provide a selected item, wherein the consumer agrees to finance the selected item according to the loan agreement; and a means for delivering the selected item to the consumer 20. The means for delivering the selected item may be the United States Postal System™, truck, messenger, hand delivery, FedEx™, and other delivery methods known within the art. The system according to the present invention is a distributed system of computers and database, wherein information from each of these computers is complied to provide the list of negotiated terms and conditions for a loan agreement. The embodiment depicted in FIG. 1Ais a simple embodiment, wherein loan data, item information and consumer information may be compiled to determine a set of financing terms agreeable to the lender and the consumer. The consumer may also be a borrower from the lender. It is envisioned that a number of additional parties may affect the decision making process.

This system may provide for indirect financing or direct financing. Indirect financing is valuable to lenders, sellers, and consumers alike. However, prior to the invention, indirect financing was generally time consuming and costly, and was generally limited to an individual seller's access to finance product resources, and its skill and effort made in finding available finance products suitable for the customer. Moreover, depending on consumer credit quality, most credit applications that a lender receives through indirect channels do not result in a favorable outcome for anyone and yet, based on applicable Federal regulations, finance institutions are legally required to process and either approve or deny all credit applications received. For denied credit applications, the lender must prepare and forward a letter to the applicant stating that the application was denied. This procedure is costly and time consuming. It is also expensive for finance institutions to develop and maintain relationships with indirect channels. Lenders benefit from the arrangement in that they can capitalize on the “front line” presence of sellers to generate applicants for their finance products. Sellers have benefited in two ways: one, their customer is able to obtain funds to buy their goods; and two, the lender will often reward the seller for sending them a new customer. The consumer's benefit by obtaining financing for something they desire on terms acceptable to them. However, the system may also provide direct financing, where a company acts as vendor 10 and lender 30.

FIGS. 1B-1C show in the browser window 24, item 1, item 2 and item 3 which the consumer may select for purchase. Each item may have a cost saving associated with its efficiency. This may include a direct cost saving, or a subsidy provided by a governmental agency. By way of example, Item 1 may be a Ground Source Heat Pump manufactured by Hydron Module® which may reduced heating and cooling costs. For each specific model, a cost savings associated with increased efficient may be listed, as shown in FIG. 1C. For example, it may be estimated that in the month of January average heating costs with a standard heat pump are $100. Optionally, the consumer 20 may input specific information into their computer 22 regarding their location and heating and cooling costs. Estimated cost savings for each month may be provided, as well as a yearly total for each item. Also, the upfront cost of the item may be provided. For each item, it may be listed the average payback time to recoup the upfront costs. A payment plan should be listed, wherein the consumer 20 never makes a payment more than the cost savings associated with the item. Vendors 10 also benefit from this, in that their product becomes much more attractive and affordable. Also, vendors 10 gain the Green image, which provide invaluable goodwill.

The consumer 20, may select an item, for example item 1, by clicking on “click here” 26. As shown in FIG. 1C, a list of negotiated terms 110 may be presented to the consumer 20, lender 30 and vendor 10. The negotiated terms 110 may be viewable to one of the parties, all of the parties or some of the parties to the transaction. For example, it may be desirable for the consumer 20 and the lender 30 to be able to view the negotiated terms. However, the vendor 10 may not be allowed to view the negotiated terms 110.

Once a consumer selects an item, they must provide information regarding their credit in order to complete the sale, as shown in FIG. 1D. This may include name 62, Social Security Number 64, Address 66 and Zip Code 68. A credit check may then determine the credit worthiness of the consumer. The creditworthiness of the consumer may affect the interest rate being offered and the payback period. However, the costs associated with the purchase of the item, or the total monthly cost of the increased efficiency item (Pₑₘ) should never be more than the price of the increased efficiency equipment price of similar. It should be understood, that this is merely one example. Monthly payments are generally a standard payment period, or that which is referred to as the specified period. However, the present invention may be used for quarterly payments, or any other specified period without limitation. The total monthly cost of the increased efficiency item (Pₑₘ) may be structured in a number of ways. There may be a separate loan for the difference between total monthly cost of the increased efficiency item (Pₑₘ) and the cost of the standard item (Psm). Also, there may be a single loan for the entire cost of the increased efficiency item. It should also be understood, that the term loan may also mean a line of credit or credit being used to pay a debt. However, the total monthly cost of the increased efficiency item (Pₑₘ) should always be less or equal to the monthly cost of the standard item plus the cost savings associated with the increased efficiency item. This may be demonstrated by the following formula.

$Pₑₘ $Pₛₘ+$Cₛ

As in the above example, the total monthly cost of the increased efficiency item (Pₑₘ) may be $80/month ($60 to principal, $20 debt servicing fees). While the price of a standard item (Pₛₘ) may be $60/month and the associated cost savings (Cₛ) may be $60/month. According to the above formula:

Pₑₘ Pₛₘ+Cₛ

$80 $60+$60

The total monthly cost of the increased efficiency item may fluctuate (Pₑₘ), as may the cost savings (Cₛ). For example, the efficiency of the item may save you 50% to 70% on heating costs and only 20% to 30% on cooling costs. Also, the interest rate may effect the total monthly cost of the increased efficiency item ($Pₑₘ). As discussed previously, the credit rating of the consumer may vary, which in turn may affect the costs associated with the loan, which in turn affects the total monthly cost of the increased efficiency item. Therefore, the cost savings may vary from month to month. Regardless of the variations, though, the monthly payment for the increased efficiency item should never be more than the monthly price of the standard item plus the cost savings. This may be termed “pay less than you save”. It is preferred that the loan be variable, to account for fluctuations in interest rates and costs associated with increased efficiency items. However, the interest rates may be fixed. As shown in FIG. 1E, the prices per period (e.g. monthly) may be displayed (e.g. Item 1, Item 2) and a consumer may select 53 by clicking on a button.

While the “pay less than you save feature” is certainly attractive, another advantage realized by the present systems and methods disclosed herein is the competitive pricing of increased efficiency items. It is envisioned that mass purchasing power will be obtained through the increased number of consumers, increased efficiency of the sale and low overhead. As such, it is envisioned that the purchase price of the increased efficiency item may be less than or equal to retail.

As shown in FIGS. 1A-1F there is a means for receiving loan data 100 from lenders 30 and for storing the loan data 100 in a computer storage device, which may be a database 102. There is a means for receiving item information 104 from vendors 10 regarding at least one item and for storing item information in a database 102. There is a means for determining estimated cost benefits to consumer for each item. This may be derived from the vendor 10, or from a separate database or website. There is a means accessible to the database 102 for using loan data 100, item information 104 and estimated benefits to create a list of negotiated terms 110 and conditions of a loan agreement for each item with an identified lender 30. There is a means for receiving a selection 106 from the consumer 20 for at least one item to provide a selected item, wherein the consumer 20 agrees to finance the selected item according to the loan agreement. The customer may pay the loan agreement through credit which they previously had, or applied for at the time of purchase. There is a means for delivering the selected item 120 to the consumer 20. Where financed, the consumer 20 may also receive a bill 121 from the lender 30.

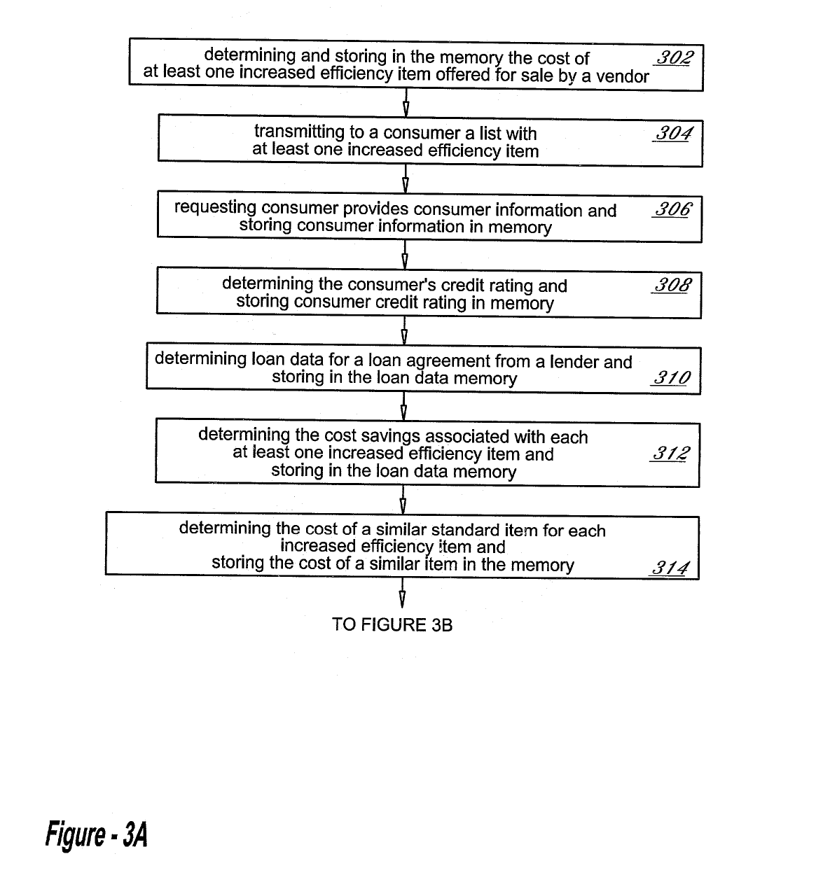

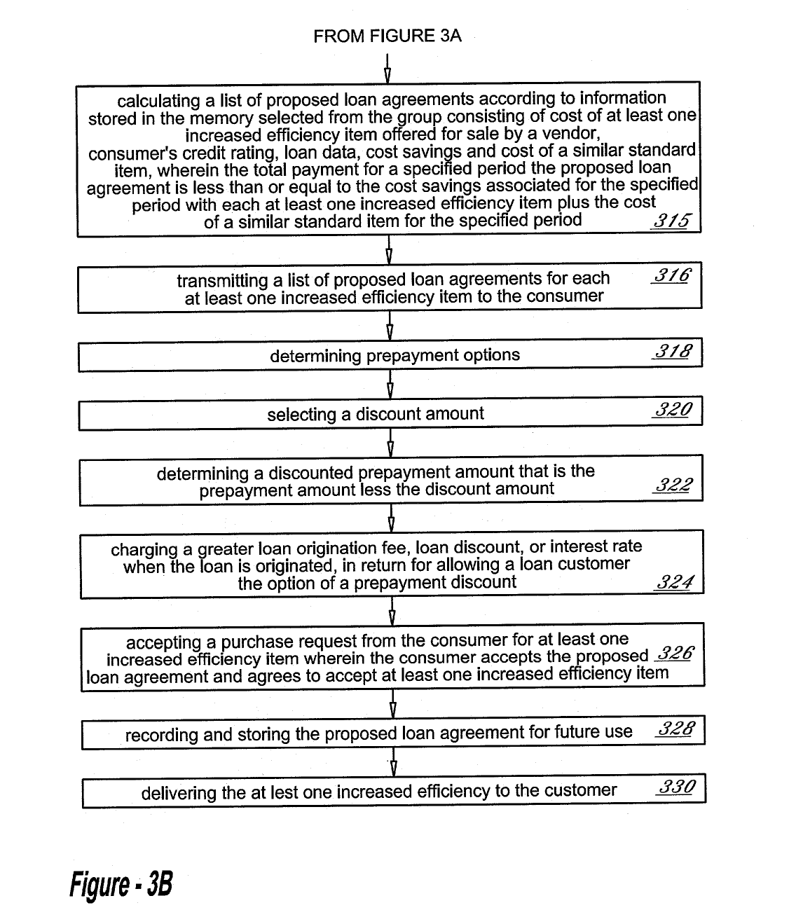

In the case of a fixed interest rate, the lender may require that the consumer reestablish the interest credit rate each year on the interest crediting date, which resets periodic compensation. Whereas in the past, generally credit changes and interest rates have been the two variables utilized to reestablish the interest credit rate, the present invention utilizes a third variable, cost savings realized by the piece of equipment purchased with the funds. The periodic compensation may be reset, where if the formula rate exceeds a maximum rate cap, maximum annual rate, or estimated cost savings, the lender covenants to establish the new rate at the lower of the three rates. This data is stored in the computer storage device. If the formula is below a minimum target rate, the lender contracts to use its best efforts to establish the rate at or above the minimum target rate, but agrees that under no circumstances will the rate be set below the minimum interest rate. If the formula rate is above the minimum target rate and below the maximum rate cap, maximum annual rate or estimated cost savings, then the lender agrees to establish the rate between the lower of the maximum rate cap, maximum annual rate, estimated cost savings and the formula rate. This information is stored in the system database 102. Terms of acceleration, premature termination or prepayment of the financial instrument may be negotiated (See FIG. 2, Step 214, Step 216 and FIG. 3, Step 318, Step 322, Step 324).

FIG. 1G depicts a system of computers for matching vendors 10, consumers 20 and lenders 30 for an increased efficiency item (for example 158, 160, 162). The system comprises a means for receiving loan data 134 from lenders, which may be a lender computer 136, and for storing loan data 134 in a computer storage device, which may be database 102. The loan data 134 includes at least one of principal balance of the loan, term, initial period interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, and currency of the loan. There may be a means for receiving item information 138 from vendors 10 regarding at least one increased efficiency item (for example 158, 160, 162) and for storing item information 138 in a computer storage device, for example database 102, database 103. Item information may include estimated cost savings for each at least one increased efficiency item, million metric ton carbon emissions reductions, actual cost savings for each at least one increased efficiency item (for example 158, 160, 162), life expectancy for each at least one increased efficiency item, payback time, life expectancy and value of currency. There is also a means, which may be host system 132, for determining estimated cost benefits, in comparison to a standard comparable item, to the consumer for each at least one increased efficiency item (for example 158, 160, 162). There is also a means accessible to the computer storage device, for example database 102, for using loan data 134, item information 138 and estimated benefits to create a list of negotiated terms and conditions of a loan agreement 140 for each at least one increased efficiency item within an identified lender (for example lender 136, lender 32) wherein the means accessible to the computer storage device, for example databases 102 and 103, for using the loan data 134 is a host system 132. There may be a loan agreement negotiation means 144, which may be within host system 132, coupled to the computer storage device, databases 102 and 103, for the consumer (for example, consumer 22) and at least one lender (for example, lender 136) to enter, record and store the terms of the loan agreement, prepayment terms, loan adjustments. The loan adjustments comprising changes to costs, points, rates, margins, external benchmarks, caps or life caps to be made. There may be a restriction means coupled 146, which may be coupled to the computer storage device, which may be as shown databases 102 and 103, for identifying and entering particular terms under which funds received from the issuance of the loan agreement will be accepted by the consumer. The consumer may receive the funds 150 in exchange for credit 152. There may be a means for receiving credit payment 148 from the consumer (for example, consumer 22) to finance a selected item according to the loan agreement 140. There may be a means for receiving a selection 150 from the consumer (for example, consumer 22) for at least one increased efficiency item to provide a selected item, wherein the consumer agrees to finance the selected item according to the loan agreement 140 with credit 152; and a means, as depicted by truck 154, for delivering the selected item to the consumer (consumer 22). While a system of computers (as shown by vendor 12, consumer 20, lender 32) is preferred for use in carrying out the present system and method, alternative means may be used including telephone networks, facsimile machines, automatic typewriters, and other known office equipment and means for recording and storing information, for displaying such information and for communicating information rapidly including directly communicating between offices.

FIG. 2, depicts a method for offering incentives related to the purchase of increased efficiency items according to the present invention. The method may comprise the steps 200 offering to a consumer at least one increased efficiency item. This may include any consumer or commercial item. However, it is envisioned that according to a preferred embodiment, the present invention is particularly well suited for consumer items on the order of between $300 and $15,000. Step 202 requesting the consumer provides consumer information. This may include a login Id and password where the user has previously utilized the systems or method. Where the user is a first time user, they may input information including their name, address, social security number, current energy costs, desired product, and any other information that may be useful. Step 204 determining the consumer's credit rating. This may be obtained from a third party, such as Equifax. Step 206 determining loan data for a loan agreement. By way of example, this may include the principal balance of the loan, term, interest rate, initial period interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, external benchmark and currency of the loan. The interest rate may be fixed or variable. The term may vary according to any agreed period of time from months to years. The external benchmark may be LIBOR or any benchmark presently known or based upon general benchmark standards.

Step 208 determining the cost savings associated with each at least one increased efficiency item. For example, it may be determined that a certain formula equals the estimated cost savings associated with each at least one increased efficiency item. By way of example, the formula may be as follows:

Cₛ=Cᵢₑₘ−Cₛᵢₘ

Where Cₛ is the Cost Savings, Cᵢₑₘ is the monthly cost of operating the increased efficiency item and Csim is the monthly cost of operating the standard item. However, it should be understood that other factors may play into the cost savings, and this is merely an example. Government entities, for example, may offer incentives for decreased emissions. It should be noted that many of the variables that go into determining the cost savings may fluctuate and should be periodically recalculated. For example, the value of the American dollar may fluctuate, as may oil prices, interest rates, etc. Also, the cost of operating a heater may be greatly increased over the winter months when compared to the summer months. It may be possible to have an estimated set of values for the cost savings associated with a particular increased efficiency item, which may be retrieve over the Internet and stored remotely in a database. These values may be based on previous, actual cost savings or estimated. However, where a cost savings is not available it may be possible to utilize actual values for the savings achieved in conjunction with the cost of a similar standard item (that is, not increased efficiency) to determine the cost savings.

The next step 210 may be determining the cost of a similar standard item for each at least one increased efficiency item. Step 212 providing a proposed loan agreement for each increased efficiency item wherein the total monthly payment for the proposed loan agreement is less than or equal to the cost savings associated with each at least one increased efficiency item plus the cost of a similar standard item. In this way, the consumer should never pay more for an increased efficiency item, when calculating in operating or other associated costs, than they would for a similar standard item.

Step 214 is optional, and may consist of determining prepayment options. This may also include steps of: selecting a discount amount; and determining a discounted prepayment amount that is the prepayment amount less the discount amount. The discount amount may also be less than the difference between the prepayment amount and the present value of the prepayment amount. Step 216 is also optional and may consist of charging a greater loan origination fee, loan discount, or interest rate when the loan is originated, in return for allowing a loan customer the option of a prepayment discount.

Step 218 consumer provides loan agreement conditions under which the consumer would accept the loan. For example, the consumer may say, if I can get the total monthly payment below $300/month I would accept the loan and purchase the product. In this way, the vendor and the lender know the consumers price point and may adjust accordingly. For example, lenders and vendors may get a list of possible loans every day, where the consumer has chosen acceptable parameters. They may then chose to accept or decline the loan. It is also envisioned that this process may be automated. Also, the offer to purchase may be stored and acceptance of the offer to purchase emailed at a later date. As discussed previously, the price a consumer is willing to buy at one point in time may not be desirable to all the parties. However, given the fluctuating nature of many of the variables, the price may be acceptable to the parties at a later date. For example, the interest rates may drop, consumer credit rating may increase, etc.

Step 220 consumer selecting at least one increased efficiency item. Step 222 recording and storing the proposed loan agreement for future use. This step may occur at a number of different points. For example, if the consumer decides to think about the terms of the loan or shop around, the proposed loan agreement may be saved in a database or any other information storing system known within the art. Also, if the consumer decides to accept the terms of the loan, the terms may be saved in a database and periodic (e.g. monthly) statements generated according to this. The consumer may select a specific item, according to step 224 of accepting the loan agreement. For example, the consumer may agree to purchase Model X geothermal heat pump, at a financing rate of 8% for a period of 10 years. According to this plan, the total payments for specified period (monthly) for the increased efficiency item may be $350. However, the consumer may realize a cost savings of $100, making their monthly payment $250 per month, which is less than the cost of the standard items $260 price tag. In this way, a number of parties have benefited from the process. The consumer has purchased a higher efficiency item, which after the item is paid for, will continue to save the consumer money. The vendor has made their product more desirable to the consumer, by being able to provide a lower total monthly cost. The lender has agreed to the loan terms and is making money on the debt.

Step 226 may be providing credit payment to pay the proposed loan agreement. The consumer may provide credit payment from their own credit card. Also, third parties may provide credit payment. For example, there may be a link on the host system to a credit card provided. The consumer may apply for credit, and if received use this credit to make credit payment according to the proposed loan agreement. The host system may charge a fee to third parties for this link. The third party may also be a mortgage company. For higher priced items, or where the consumer may not have sufficient credit, a second mortgage may be appropriate. The mortgage company may be required to pay a fee to the host system for the link. In is envisioned that a number of different methods for obtaining credit payment may be utilized.

It should be noted that the cost of energy to operate a device is often greater than the cost of purchasing the item itself. Thus, a gas fired central heating system might cost $4,000 to $5,000 to purchase, but cost $1,000 per year for the energy needed for it to serve it's function. If the heating system has a rated life expectancy of 20 years, $20,000 will have been spent on energy to operate a $5,000 item.

FIG. 3 depicts a method of providing a loan for the purchase of increase efficiency items through a distributed system of computers comprising memory for storing loan information including a principal balance of the loan, a term of the loan, and an interest rate of the loan. The first step 302 may be determining and storing in the memory the cost of at least one increased efficiency item offered for sale by a vendor. Step 304 transmitting to a consumer a list with at least one increased efficiency item. Step 306 requesting consumer provides consumer information and storing consumer information in memory. Step 308 determining the consumer's credit rating and storing the consumer's credit rating in memory. Step 310 determining loan data for a loan agreement from a lender and storing in the loan data in memory. Step 312 determining the cost savings associated with each at least one increased efficiency item and storing the cost savings in the memory. Step 314 determining the cost of a similar standard item for each increased efficiency item and storing the cost of a similar standard item in the memory. Step 315 calculating a list of proposed loan agreements according to information stored in the memory. The information stored in memory may include of at least one increased efficiency item offered for sale by a vendor, consumer's credit rating, loan data, cost savings and cost of a similar standard item. The total payment for the specified period of proposed loan agreement is less than or equal to the cost savings associated with each at least one increased efficiency item for the specified period plus the cost of a similar standard item for the specified period. Step 316 transmitting a list of proposed loan agreements for each at least one increased efficiency item to the consumer. Step 318 determining prepayment options. Step 320 selecting a discount amount. Step 322 determining a discounted prepayment amount that is the prepayment amount less the discount amount. Step 324 charging a greater loan origination fee, loan discount, or interest rate when the loan is originated, in return for allowing a loan customer the option of a prepayment discount. Step 326 accepting a purchase request from the consumer for at least one increased efficiency item wherein the consumer accepts the proposed loan agreement and agrees to accept at least one increased efficiency item. Step 328 recording and storing the proposed loan agreement for future use. Step 330 may be optional, wherein the consumer provides conditions under which they would accept a loan. It is envisioned that these condition would be transmitted to a vendor or lender, and where the vendor or a lender and where the conditions are acceptable to the parties involved, the conditions may be agreed to.

It should be understood, of course, that the foregoing relates to preferred embodiments of the invention and that modifications may be made without departing from the spirit and scope of the invention as set forth in the following claims.

I claim:

1. A system for matching vendors, consumers and lenders for an increased efficiency item, comprising:
means for receiving loan data from lenders and for storing said loan data in a computer storage device;
means for receiving item information from vendors regarding at least one increased efficiency item and for storing said item information in a computer storage device;
means for determining estimated cost benefits to said consumer for each said at least one increased efficiency item;
means accessible to said computer storage device for using said loan data, said item information and said estimated benefits to create a list of negotiated terms and conditions of a loan agreement for each said at least one increased efficiency item within an identified lender;
means for receiving a selection from said consumer for at least one increased efficiency item to provide a selected item, wherein said consumer agrees to finance said selected item according to said loan agreement; and
means for delivering said selected item to said consumer.

2. A system as in claim 1, further comprising a means for receiving credit payment from said consumer to finance said selected item according to said loan agreement.

3. A system as in claim 1, wherein a single entity acts as both lender and vendor.

4. A system as in claim 1, wherein said means accessible to said computer storage device for using said loan data, said item information and said estimated benefits to create a list of negotiated terms and conditions of a loan agreement for each said at least one increased efficiency item within an identified lender is a host system.

5. A system as in claim 1, wherein said item information includes at least one of the following:
estimated cost savings for each said at least one increased efficiency item, million metric ton carbon emissions reductions, actual cost savings for each said at least one increased efficiency item, life expectancy for each said at least one increased efficiency item, payback time, life expectancy and value of currency.

6. A system as in claim 1, wherein said wherein said loan data includes at least one of the following:
principal balance of the loan, term, initial period interest rate, interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, external benchmark and currency of the loan.

7. A system as in claim 1, further comprising:
a loan agreement negotiation means coupled to said computer storage devices for the consumer and at least one lender to enter the terms of said loan agreement, external benchmarks, loan adjustments, said loan adjustments comprising changes to costs, external benchmarks, points, rates, margins, caps or life caps to be made.

8. A system as in claim 1, wherein said increased efficiency item is energy efficient.

9. A system as in claim 1, further comprising:
restriction means coupled to said computer storage device for identifying and entering particular terms under which funds received from the issuance of the loan agreement will be accepted by said consumer.

10. A system as in claim 1, further comprising:
prepayment means coupled to said computer storage device for determining, recording and storing at issuance of the loan agreement the terms under which the consumer could partially or wholly prepay the loan of the agreement during its term.

11. A system as in claim 1, wherein said lender is chosen from the group consisting of an insurance company, bank, corporation, individual, trust, mutual fund, investment company, partnership, limited partnership, or other incorporated or unincorporated entity.

12. A system as in claim 1, wherein said vendor is chosen from the group consisting of an insurance company, bank, corporation, individual, trust, mutual fund, investment company, partnership, limited partnership, or other incorporated or unincorporated entity.

13. A system as in claim 1, wherein said consumer is chosen from the group consisting of an insurance company, bank, corporation, individual, trust, mutual fund, investment company, partnership, limited partnership, or other incorporated or unincorporated entity.

14. A system for matching vendors, consumers and lenders for an increased efficiency item, comprising:
means for receiving loan data from lenders and for storing said loan data in a computer storage device, wherein said loan data includes at least one of principal balance of the loan, term, initial period interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, currency of the loan;
means for receiving item information from vendors regarding at least one increased efficiency item and for storing said item information in a computer storage device;
means for determining estimated cost benefits, in comparison to a standard comparable item, to said consumer for each said at least one increased efficiency item;
means accessible to said computer storage device for using said loan data, said item information and said estimated benefits to create a list of negotiated terms and conditions of a loan agreement for each said at least one increased efficiency item within an identified lender, wherein said means accessible to said computer storage device for using said loan data is a host system;
loan agreement negotiation means coupled to said computer storage devices for the borrower and at least one lender to enter, record and store the terms of the loan agreement, prepayment terms, loan adjustments, said loan adjustments comprising changes to costs, points, rates, margins, external benchmarks, caps or life caps to be made;
restriction means coupled to said computer storage device for identifying and entering particular terms under which funds received from the issuance of the loan agreement will be accepted by said consumer;
means for receiving credit payment from said consumer to finance said selected item according to said loan agreement;
means for receiving a selection from said consumer for at least one increased efficiency item to provide a selected item, wherein said consumer agrees to finance said selected item according to said loan agreement with said credit; and
means for delivering said selected item to said consumer.

15. A system as in claim 14, wherein a single entity acts as both lender and vendor.

16. A system as in claim 14, wherein said increased efficiency item is energy efficient.

17. A system as in claim 14, wherein said lender is chosen from the group consisting of an insurance company, bank, corporation, individual, trust, mutual fund, investment company, partnership, limited partnership, or other incorporated or unincorporated entity.

18. A system as in claim 14, wherein said vendor is chosen from the group consisting of an insurance company, bank, corporation, individual, trust, mutual fund, investment company, partnership, limited partnership, or other incorporated or unincorporated entity.

19. A system as in claim 14, wherein said consumer is chosen from the group consisting of an insurance company, bank, corporation, individual, trust, mutual fund, investment company, partnership, limited partnership, or other incorporated or unincorporated entity.

20. A method for offering incentives related to the purchase of increased efficiency items, said method comprising the steps of:
offering to a consumer at least one increased efficiency item;
determining said consumer's credit rating;
determining loan data for a loan agreement;
determining the cost savings associated with each said at least one increased efficiency item; and
providing a proposed loan agreement for each said at least one increased efficiency item, wherein the total payment for a specified period of said proposed loan agreement is less than or equal to said cost savings associated for said specified period with each said at least one increased efficiency item plus said cost of a similar standard item for said specified period.

21. A method as in claim 19, further comprising the step:
providing credit payment to pay said proposed loan agreement.

22. A method as in claim 21, wherein said consumer provides credit payment through a previously existing credit card.

23. A method as in claim 21, wherein a third party provides credit to said consumer and said consumer in turn provides credit payment for said loan agreement.

24. A method as in claim 20, wherein said step of determining the costs savings further comprises the step of:
determining the cost of a similar standard item for each said at least one increased efficiency item.

25. A method as in claim 20, wherein said loan data includes at least one of the following: principal balance of the loan, term, initial period interest rate, interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, currency of the loan.

26. A method as in claim 20, further comprising the step of requesting said consumer provides consumer information.

27. A method as in claim 20, further comprising the step of said consumer provides conditions under which said consumer would accept a loan.

28. A method as in claim 20, wherein said step of determining the cost savings associated with each said at least one increased efficiency item is retrieved over the Internet.

29. A method as in claim 20, further comprising the step of said consumer selecting at least one increased efficiency item.

30. A method as in claim 20, further comprising the step of accepting said proposed loan agreement.

31. A method as in claim 20, further comprising the step of determining prepayment options.

32. A method as in claim 20, wherein said step of determining prepayment options further comprises the steps of:
selecting a discount amount; and
determining a discounted prepayment amount that is the prepayment amount less the discount amount.

33. A method as in claim 20, wherein said discount amount is less than the difference between the prepayment amount and the present value of the prepayment amount.

34. A method as in claim 20, further comprising the step of:
charging a greater loan origination fee, loan discount, or interest rate when the loan is originated, in return for allowing a loan customer the option of a prepayment discount.

35. A method as in claim 20, further comprising the steps of:
recording and storing said proposed loan agreement for future use.

36. A method as in claim 20, further comprising the steps of:
providing a payback period, wherein said payback period is always less than the useful like of said increased efficiency item.

37. A method of implementing through a distributed system of computers, a loan for the purchase of increase efficiency items in the distributed system of computers comprising memory, said memory storing loan information including a principal balance of the loan, a term of the loan, and an interest rate of the loan, said method comprising the steps of:
determining cost of at least one increased efficiency item offered for sale by a vendor and storing said cost of at least one increased efficiency item offered for sale by a vendor is said memory;
transmitting to a consumer a list with at least one increased efficiency item;
determining said consumer's credit rating and storing said consumer's credit rating in said memory;
determining loan data for a loan agreement from a lender and storing said loan data in said memory;
determining the cost savings associated with each said at least one increased efficiency item and storing said cost savings in said memory;
determining the cost of a similar standard item for each said at least one increased efficiency item and storing said cost of a similar standard item in said memory;
calculating a list of proposed loan agreements according information stored in said memory selected from the group consisting of said cost of at least one increased efficiency item offered for sale by a vendor, said consumer's credit rating, said loan data, said cost savings and said cost of a similar standard item, wherein the total payment for said proposed loan agreement for a specified period is less than or equal to said cost savings associated for said specified period with each said at least one increased efficiency item plus said cost of a similar standard item for said specific period;
transmitting said list of proposed loan agreements for each said at least one increased efficiency item to said consumer;
accepting a purchase request from said consumer for said at least one increased efficiency item wherein said consumer accepts said proposed loan agreement and agrees to accept said at least one increased efficiency item;
providing credit payment to pay said proposed loan agreement; and
delivering said at least one increased efficiency to said consumer.

38. A method as in claim 37, wherein said consumer provides credit payment through a previously existing credit card.

39. A method as in claim 37, wherein a third party provides credit to said consumer and said consumer in turn provides credit payment for said loan agreement.

40. A method as in claim 37, wherein said loan data includes at least one of the following: principal balance of the loan, term, initial period interest rate, interest rate, compounding and interest rate crediting dates, terms for determining a formula interest rate applicable for a given period of time, a lifetime maximum interest rate, a maximum periodic, a life time minimum interest rate, a periodic minimum interest rate, estimated cost savings, an interest rate tied to an external benchmark, currency of the loan.

41. A method as in claim 37, further comprising the step of requesting said consumer provides consumer information and storing said consumer information in said memory.

42. A method as in claim 37, wherein said step of determining the cost savings associated with each said at least one increased efficiency item is retrieved over the Internet.

43. A method as in claim 37, further comprising the step of determining prepayment options and storing said prepayment options in said memory.

44. A method as in claim 37, wherein said step of determining prepayment options further comprises the steps of:
selecting a discount amount; and
determining a discounted prepayment amount that is the prepayment amount less the discount amount.

45. A method as in claim 37, wherein said discount amount is less than the difference between the prepayment amount and the present value of the prepayment amount.

46. A method as in claim 37, further comprising the step of:
charging a greater loan origination fee, loan discount, or interest rate when the loan is originated, in return for allowing a loan customer the option of a prepayment discount.

47. A method as in claim 37, further comprising the steps of:
recording and storing said proposed loan agreement for future use.

48. A method as in claim 37, further comprising the steps of:
said consumer providing conditions under which said consumer would accept a loan.

49. A method as in claim 37, further comprising the steps of:
providing a payback period, wherein said payback period is always less than the useful like of said increased efficiency item.
